(19) United States
(12) Patent Application Publication
(10) Pub. No.: US 2007/0022117 A1
(43) Pub. Date: Jan. 25, 2007

(54) Accessing file system snapshots directly within a file system directory

(76) Inventors: Susann M. Keohane, Austin, TX (US); Gerald F. McBrearty, Austin, TX (US); Shawn P. Mullen, Buda, TX (US); Jessica Murillo, Round Rock, TX (US); Johnny M. Shieh, Austin, TX (US)

Correspondence Address: IBM CORP (AP);C/O AMY PATTILLO, P. O. BOX 161327, AUSTIN, TX, 78716, US

(21) Appl. No.: 11/186,701

(22) Filed: Jul. 21, 2005

(51) Int. Cl. G06F 17/30

(52) U.S. Cl. 707/8

(57) ABSTRACT

A file system controller of an operating system controls the management of a file system, including the creation of file system snapshots or other backup copies of data in the file system to at least one storage device. In addition, the file system controller creates a named data stream attached to an entry for the data copied in the snapshot in a file system directory for the file system. The named data stream holds a reference to the storage location of the snapshot within the storage device. The file system controller provides access to the file system snapshot via the named data stream. In particular, a user may enter a single command to list the contents of the file system directory and the file system controller returns a single response listing both the entry for the data and the named data stream referencing the snapshot of the data.

### BACKGROUND OF THE INVENTION

1. Technical Field

The present invention relates in general to improved file system management. Still more particularly, the present invention relates to accessing file system snapshots directly within a file system directory.

2. Description of the Related Art

To an end user, most computer systems have the same general structure for storing and accessing data, that is, by placing the data in “files” whose names have a particular format, and placing files in “folders” or “directories” to further organize them. These file objects are physically encoded into the machine's storage device, e.g. hard disk. Computer operating systems such as UNIX or MS-DOS use this type of a filing system (“UNIX” is a trademark of UNIX System Laboratories; MS-DOS is a trademark of Microsoft Corp.). In these systems, each file has a unique path name which identifies its location within the file structure. UNIX and MSDOS computers have a “root” directory from which other directories or sub-directories branch out; in a UNIX operating system, the root directory is designated by the forward slash symbol (“/”), which is also used to separate parts of the path name. For example, the path name “/pdir/sdir/myfile” refers to a file named “myfile” that is located in the “sdir” subdirectory, which is, in turn, located in the primary directory “pdir” at the root level.

Processes and users interact with the file system using a specific set of commands, such as “open”, “read”, and “copy”. More specifically, processes and users interact with a UNIX based file system by entering “cd” to change to a new directory and “ls” to receive a list of the files in a current directory.

An important attribute of an operating system that supports a file system, is the backup support for the file system. In one example, a snapshot function of an operating system copies all or portions of a file system, and maintains a read-only copy that reflects the state of the file system at the time of creation of the file system snapshot for recovery purposes. The snapshot requires disk space for storage of the copied files.

A limitation of a file system snapshot is that currently, the directory for the file system snapshot is actually mounted separately from the file system directory. In particular, even though the user may perceive the directories of the snapshot directory as hidden subdirectories of the file system directory, in reality, the snapshot directory is mounted separately from the file system directory. Mounting the snapshot directory separately from the file system directory is limited because to perform file recovery from a snapshot file, a user must first specifically mount the snapshot directory. For example, the user must first enter “cd snapshot” or “cd/root/snapshot” to mount the snapshot directory. Then, to recover a particular file or directory in the file system from the snapshot, the user traverses the snapshot directory to locate the copy of a particular file or directory of the file system for replacement.

Therefore, in view of the foregoing, it would be advantageous to provide a method for integrating a snapshot directory directly into a file system directory, such that to search for a snapshot file listing, a user need not mount a separate snapshot directory.

### SUMMARY OF THE INVENTION

Therefore, the present invention provides, in general, improved file system backup management and in particular, provides for accessing file system snapshots directly within a file system directory.

A file system controller of an operating system controls the management of the file system, including the creation of file system snapshots or other backup copies of data in the file system to at least one storage device. In addition, the file system controller creates a named data stream attached to an entry for the data copied in the snapshot in a file system directory for the file system. The named data stream holds a reference to the storage location of the snapshot within the storage device. The file system controller provides access to the file system snapshot via the named data stream. In particular, a user may enter a single command to list the contents of the file system directory and the file system controller returns a single response listing both the entry for the data and the named data stream referencing the snapshot of the data.

When the file system controller receives a command to delete data from the file system, the file system controller deletes the data from the storage device, attaches any named data streams referencing snapshots to a preceding directory within the file system directory, and deletes the entry for the data from the file system directory. When a user commands the file system controller to list the contents of the preceding directory, the file system controller returns the named data stream attached to the preceding directory in the response.

As an alternative to a named data stream, the file system controller may create an extended attribute that is attached to the entry for the data, where the extended attributes holds the references to the storage location of the snapshot within the storage device. An extended attribute is hidden from listings of directory contents, unless specifically requested. A user may select preferences as to whether the file system controller, when creating an attached reference to the location of the snapshot within the storage device, should create a named data stream or extended attribute, based on criteria such as the directory holding the entry for the data and the type of the data.

The file system controller may create the snapshot references responsive to different triggers. In one embodiment, where a snapshot reference is created responsive to the creation of a snapshot of a file or responsive to a command to write to file, the snapshot reference is attached to the file name within the file system directory in memory and the snapshot reference is flushed to the file system within disk space. In another embodiment, the file system controller may dynamically create snapshot references responsive to user request to discover the contents of a particular directory or file. The file system controller determines the locations of valid snapshots associated with the directory or file and dynamically creates the snapshot references in the file system directory in memory.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram depicting a computer system in which the present method, system, and program may be implemented;

FIG. 2 is a diagram illustrating components used in creating and managing a snapshot of a file system;

FIG. 3 is a diagram depicting a file system directory with references to snapshots integrated into the file system directory;

FIG. 4 is diagram illustrating snapshot reference preferences; and

FIG. 5 is a high level logic flowchart depicting a process and program for controlling the creation and management of snapshot references in the file system directory.

### DETAILED DESCRIPTION OF THE PREFERRED EMBODIMENT

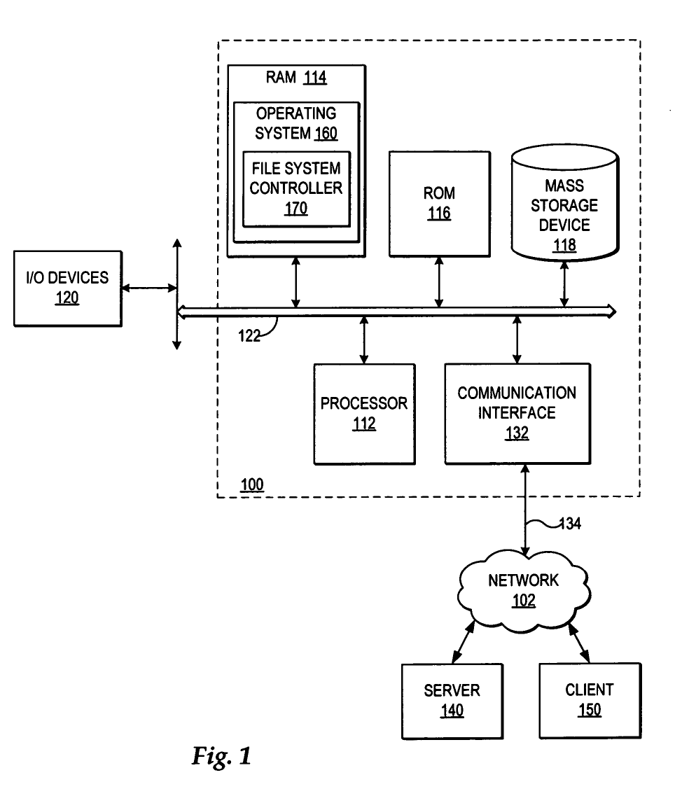

Referring now to the drawings and in particular to FIG. 1, there is depicted one embodiment of a computing system through which the present method, system, and program may be implemented. The invention may be executed in a variety of systems, including a variety of computing systems and electronic devices.

Computer system 100 includes a bus 122 or other communication device for communicating information within computer system 100, and at least one processing device such as processor 112, coupled to bus 122 for processing program code and data. Bus 122 may include low-latency and higher latency paths that are connected by bridges and adapters and controlled within computer system 100 by multiple bus controllers. Processor 112 may be a general-purpose processor such as IBM's PowerPC (PowerPC is a registered trademark of International Business Machines Corporation) processor. When implemented as a server system, computer system 100 typically includes multiple processors designed to improve network servicing power.

Processor 112 is coupled, directly or indirectly, through bus 122 to memory elements. During normal operation, processor 112 processes data under the control of program code accessed from the memory elements. Memory elements can include local memory employed during actual execution of the program code, such as random access memory (RAM) 114, bulk storage, such as mass storage device 118, and cache memories (not depicted) which provide temporary storage of at least some program code to reduce the number of times code must be retrieved from bulk storage during execution. In one example, the program code accessible in RAM 114 is an operating system 160. Operating system 160 includes program code that facilitates, for example, a graphical user interface (GUI) via a display 124 and other output interfaces. In addition, operating system 160 includes a file system controller 170, which is the program code used to create and manage a file system.

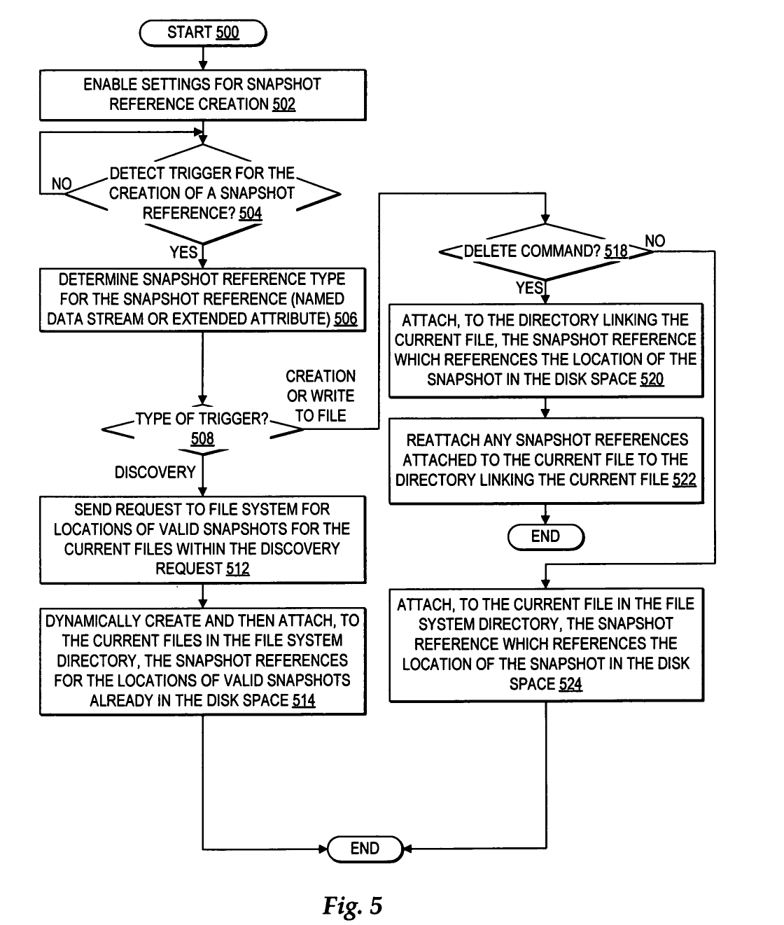

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc. For example, in one embodiment, a file system controller 170, of operating system 160, contains program code that when executed on processor 112 creates and manages a file system by carrying out the operations depicted in the flow diagrams and flowchart of FIG. 5, for example, and other operations described herein. Alternatively, the steps of the present invention might be performed by specific hardware components that contain hardwired logic for performing the steps, or by any combination of programmed computer components and custom hardware components. Additionally, RAM 114 may include an application programming interface or other interface that provides extensions to enable application developers to develop software that extends the functionality of operating system 160 to include file system controller 170.

In addition, the invention can take the form of a computer program product accessible from a computer-usable or computer readable medium providing computer readable program code for use by or in connection with computer system 100 or any instruction execution system. For purposes of this description, a computer-usable or computer readable medium can be any apparatus that can contain, store, communicate, propagate, or transport the program for use by or in connection with the instruction execution system, apparatus, or device. In one example, a computer-usable or computer readable medium is any apparatus that participates in providing program code to processor 112 or other components of computer system 100 for execution.

Such a medium may take many forms including, but not limited to, electronic, magnetic, optical, electromagnetic, infrared, or semiconductor system (or apparatus or device) or a propagation medium. Examples of a computer readable medium include, but are not limited to, a semiconductor or solid state memory, magnetic tape, a flexible disk, a hard disk, a removable computer diskette, random access memory (RAM) 114, read-only memory (ROM) 116, punch cards or any other physical medium with patterns of holes, a rigid magnetic disk and an optical disk. Current examples of optical disks include a compact disc ROM (CD-ROM), a compact disc-read/write (CD-R/W) and a digital video disc (DVD). In another example, a computer readable medium may include mass storage device 118, which as depicted is an internal component of computer system 100, but may be provided as a device external to computer system 100.

A communication interface 132 including network adapters may also be coupled to the system to enable computer system 100 to become coupled to other computer systems, such as server 140 or client 150, remote printers, or storage devices through intervening private or public networks. Network adapters within communication interface 132 may include, but are not limited to, modems, cable modems, and Ethernet cards.

In particular, communication interface 132 enables coupling to other devices through a network link 134 to a network 102. For example, a local area network (LAN), wide area network (WAN), or an Internet Service Provider (ISP) may facilitate network link 134. Network link 134 may provide wired and/or wireless network communications to one or more networks, such as network 102. Network 102 may refer to the worldwide collection of networks and gateways that use a particular protocol, such as Transmission Control Protocol (TCP) and Internet Protocol (IP), to communicate with one another.

In general, network link 134 and network 102 both use electrical, electromagnetic, or optical signals that carry digital data streams. The signals through the various networks and the signals on network link 134 and through communication interface 132, which carry the digital data to and from computer system 100, are examples of forms of carrier waves transporting the information. In one example, a remote computer, such as server 140 transfers the program code for the invention to requesting computer system 100 by way of data signals embodied in a carrier wave or other propagation medium via a network link 134 to a communications interface 132 coupled to bus 122.

When implemented as a server system, computer system 100 typically includes multiple communication interfaces accessible via multiple peripheral component interconnect (PCI) bus bridges connected to an input/output controller. In this manner, computer system 100 allows connections to multiple network computers, such as client 150, via network 102.

In addition, computer system 100 typically includes input/output (I/O) devices 120 (e.g. multiple peripheral components) that facilitate communication and may hold data. These peripheral components are coupled to computer system 100 either directly or indirectly through connections to multiple input/output (I/O) controllers, adapters, and expansion slots coupled to one of the multiple levels of bus 122. Examples of I/O devices 120 include, but are not limited to audio I/O devices for controlling audio inputs and outputs, display devices for providing visual, tactile, or other graphical representation formats, a cursor control devices for controlling the location of a pointer within the display devices, and a keyboard as an interface for inputs to computer system 100. In addition, I/O devices may include thumb drives or other portable data storage devices connected to computer system 100 via the I/O controllers, adapters, or expansion slots.

Those of ordinary skill in the art will appreciate that the hardware depicted in FIG. 1 may vary. Furthermore, those of ordinary skill in the art will appreciate that the depicted example is not meant to imply architectural limitations with respect to the present invention.

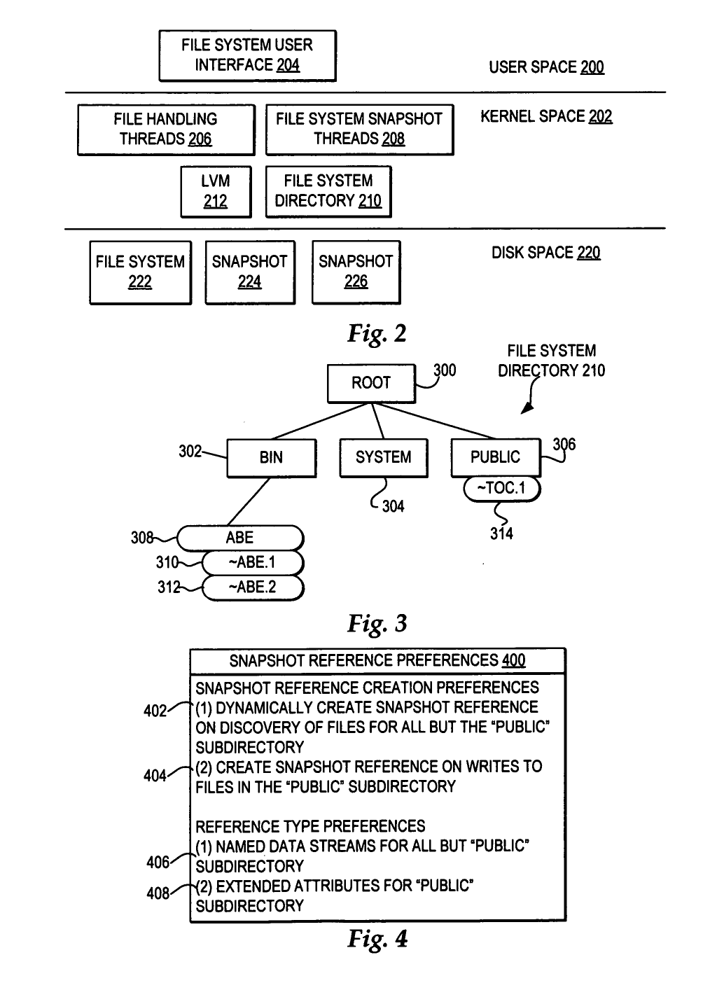

Referring now to FIG. 2, a diagram illustrates components used in creating and managing a snapshot of a file system. As used herein, the term “snapshot” is used to refer to a snapshot of a file system and may also be called a “file system snapshot”.

This example depicts user space 200, kernel space 202, and disk space 220. It will be understood that other spaces may be implemented and that components within each space may be distributed among other spaces or among multiple computer systems.

User space 200 includes file system user interface 204. File system user interface 204 receives commands, from a user, for accessing and controlling the file system. It will be understood that the user may be a person or an application.

Disk space 220 includes data logically viewed as file system 222, snapshot 224, and snapshot 226. Snapshot 224 and snapshot 226 include read-only copies of at least a portion of the data that was located in file system 222, each with data copied at different points in time. Physically, file system 222, snapshot 224, and snapshot 226 may be distributed in non-continguous sections within disk space 220. Disk space 220 may include multiple types of physical data storage media, such as mass storage device 118, RAM 114, and data storage devices accessible as I/O devices 120. It will be understood that disk space 220 may include snapshots in addition to snapshot 224 and snapshot 226. Further, it will be understood that in other computer systems, file system 222, snapshot 224, and snapshot 226 may be incorporated within disk space 220 and logically viewed as a single logical unit.

Kernel space 202, which illustrates some of the functional components of operating system 160, includes file handling threads 206, file system snapshot threads 208, and a file system directory 210. In particular, file handling threads 206, file system snapshot threads 208, and file system directory 210 represent components of file system controller 170. File system directory 210 maintains a directory of references to the data, stored as files, in file system 222, snapshot 224, and snapshot 226. File system directory 210 may include multiple levels of directories and subdirectories, with files organized under each directory and subdirectory. As will be further described, data in file system 222 is referenced in file system directory 210 by a file name and data in snapshot 224 and snapshot 226 is referenced in file system directory 210 by a named data stream attached to the file name of the associated data in file system 222.

File handling threads 206 perform file system management functions and data access, such as a read operation, write operation, or mount drive operation by accessing file system directory 210 to locate the file or files referencing the requested data. File system snapshot threads 208 implement the processes for creating a snapshot, such as snapshot 224 and snapshot 226. In one embodiment, one of file system snapshot threads 208 is triggered any time data is to be modified, such as written to or deleted from file system 222, by one of file handling threads 206. The file system snapshot thread copies the data in file system 222 to be modified into a snapshot, such as snapshot 224. It will be understood that other snapshot methods may be implemented; in alternate embodiments, file system snapshot threads 208 may determine when to copy data from file system 222 into a snapshot according to other criteria specified by a particular user or specified for a particular computer system.

In addition, kernel space 202 includes a logical volume manager 212. Logical volume manager 212 provides an interface between file handling threads 206, file system snapshot threads 208, which view the logical representations of file system 222, snapshot 224, and snapshot 226 as referenced in file system directory 210, and physical disk space 220. It will be understood that while the present invention is described with reference to logical volume manager 212 providing an interface between the operating system kernel and the physical storage devices, alternate embodiments of the invention may implement other types of data management systems for data storage and access. Further, it will be understood that while file system directory 210 is depicted within memory 216, disk space 220 may include all or portions of file system directory 210.

According to an advantage, active snapshots of file system 222 are taken, file system snapshot threads 208 also create references to the snapshot which are attached to associated file names in file system directory 210. In particular, file system snapshot threads 208 create references in the form of a named data stream. The named data stream includes the reference to the location of the copied file in snapshot 224 or 226. A character attribute of each named data stream indicates that the named data stream references a snapshot file. For example, each named data stream may include a “˜” at the beginning of the named data stream name. In one example, if a file path in file system directory 210 is /root/bin/abe, where the file is named “abe”, then the file path to the named data stream referencing the location of the snapshot of the file “abe” is /root/bin/˜abe. It will be understood that other attributes may be used to identify named data streams containing references to the locations of snapshots.

In addition, according to an advantage, when a user requests to list the contents of a particular directory within file system directory 210, a file system handling thread requests and returns a listing including both the file names within the particular directory and the named data streams attached to each file name. Therefore, by enabling access to snapshots through a named data stream, a user may access a particular snapshot file without first mounting a separate snapshot directory. Instead, since the reference to the particular snapshot file is referenced from a named data stream within file system directory 210, the user may access a snapshot file by requesting the named data stream while file system directory 210 is mounted.

Alternatively, file system snapshot threads 208 may create a snapshot reference in the form of an extended attribute, instead of a named data stream. Extended attributes can also be attached to a file or a directory within file system directory 210 in the same manner as a named data stream and are hidden unless specifically searched for. Thus, where extended attributes are used instead of named data streams, a listing of the contents of a directory only shows the file names. A user must specifically search a directory of file system directory 210 for extended attributes, and in particular extended attributes referencing a snapshot. It will be understood that in addition to named data streams and extended attributes, any other data reference type which is able to be appended to a file or directory within a file system directory, may be implemented to hold the reference to a snapshot file.

Further, according to an advantage, when a user requests to delete a file from file system 222, file system snapshot threads 208 will attach any named data streams referencing snapshot locations to the directory within file system directory 210 holding a file to be deleted, prior to or current with file handling threads 206 deleting the file. Thus, while a user may delete a file from file system 222, the snapshot of the file is not deleted and the named data stream referencing the location of the snapshot remains within file system directory 210.

In one example, snapshot references (e.g. named data streams or extended attributes) are created and attached to file names within file system directory 210 responsive to the creation of a snapshot or responsive to a command to write to a file. In one embodiment, when a snapshot reference is created responsive to the creation of a snapshot or responsive to a command to write to a file, the snapshot reference is physically attached in file system directory 210 within memory and is also flushed to file system 222 within disk space 220. It will be understood that maintaining data consistency between file system directory 210 and file system 222 is dependent upon the file system structure.

In another example, snapshot references are dynamically created and attached to file names within file system directory 210 responsive to a discovery command. Examples of a discovery command include, but are not limited to, user requests to list the contents of a particular directory or open a particular directory. When a file system snapshot thread detects a discovery command, the thread requests sends a request for file system 222 to return the locations of valid snapshot files for the discovery requested files within snapshot 224 and 226. In particular, file system 222 may maintain a directory of valid snapshot files or may search snapshots 224 and 226 for valid snapshot files. Upon the file system snapshot thread detecting the valid snapshot locations from file system 222, the file system snapshot thread dynamically creates the snapshot references and attaches the snapshot references to the associated file names within file system directory 210. Dynamically created snapshot references only exist in file system directory 210 within memory. By dynamically creating snapshot references upon a user discovery request, file system controller 170 only creates snapshot references when requested, which may provide performance benefits, including minimization of time and disk space required for snapshot reference creation.

With reference now to FIG. 3, a diagram illustrates a file system directory with references to snapshots integrated into the file system directory. In the example, file system directory 210 includes a root directory 300 and a layer of subdirectories, including bin 302, system 304, and public 306.

In the example, file system data identified by file 308, named “abe”, is located under the subdirectory bin 302. In addition, attached to file 308 is a named data stream 310, named “˜abe.1” and a named data stream 312, named “˜abe.2”. Named data stream 310 references a snapshot of the data identified by file 308 at a first point in time and named data stream 312 references a snapshot of the data identified by file 310 at a second point in time. It will be understood that in addition to named data streams 310 and 312, additional named data streams referencing other snapshots and additional named data streams or extended attributes referencing other data associated with file 308 may be attached to file 308. Further, it will be understood that the data included in named data streams or extended attributes that references the location of the snapshot may reference either the physical location or a logical location, where a logical volume manager translates the logical location into a physical location.

Based on the example directory structure in file system directory 210, if a user submits the command “ls/root/bin” the resulting list would include the following entries: “abe”, “˜abe.1”, and “˜abe.2”. Thus, using an “ls” command, which requests a listing of the contents of a particular directory or subdirectory, a user receives a list of the files under the directory and the attached named data streams that reference snapshot files for the named files. Because the snapshot directory is integrated into the file system directory in the form of named data streams attached to files, a user may locate a snapshot of a file system file at a particular point in time without mounting a separate snapshot directory.

A user may specify or an operating system may specify naming conventions for named data streams which reference the location of a snapshot. In the example, the naming conventions applied specifies that a “˜” at the beginning of the names of named data streams 310 and 312 identifies the named data streams as references to the location of a snapshot. In addition, the name of each named data stream includes the name of the file referencing the data copied in a snapshot. Further, in the example, the naming convention applied specifies that the named data stream for each snapshot instance of a particular file over time is separately identified by “.X” at the end of the name, where “X” is a number. It will be understood that other naming conventions may be applied by file system snapshot threads 208 when naming named data streams.

In addition, in the example, a named data stream 314 is attached to the subdirectory public 306. Named data stream 314 is named “˜toc.1”. Named data stream 314 references a snapshot file, as indicated by the “˜” at the beginning of the name. Named data stream 314, however, is attached to the subdirectory public 306, rather than a file. In one embodiment, a named data stream referencing a snapshot and attached to a subdirectory indicates that the data from which the snapshot was taken has been deleted from the subdirectory. For example, previously, a file named “toc” was located under the subdirectory public 306, where the file included an attached named data stream named “˜toc.1” with a reference to a snapshot of the data referenced by the file “toc” at a particular point in time. The user deleted the file “toc”, for example by entering the command “rm/root/public/toc”. In response, a file handling thread was called that deleted the file named “toc” from public 306 and file system 222 and a file system snapshot thread was called that reattached the named data stream from that file to public 306. Therefore, following the deletion, if a user submits the command “ls/root/public” the resulting list would include the following entry: “˜toc.1”. Advantageously, since the snapshot directory is integrated into the file system directory in the form of named data streams reattached to directories, when a file under that directory is deleted, a user may quickly identify snapshots remaining in file system directory 210 for deleted files.

Referring now to FIG. 4, a diagram illustrates snapshot reference preferences. In one embodiment, a user may interact with a graphical user interface to select from among the preferences illustrated within FIG. 4. In another embodiment, a user may enter commands to select from among the available selectable preferences. Preferences 400 may be used by file system controller 170 to determine when to trigger and how to control file handling threads 206 and file system snapshot threads 208.

In the example, a user may select snapshot reference creation preferences. In the example, the user selects a first preference 402 to dynamically create a snapshot reference on discovery for each directory, except public directory 306 and a second preference 404 to automatically create a snapshot reference on writes to files in public directory 306. It will be understood that a user may select additional snapshot reference creation preferences and may manually request to make a snapshot reference at a particular point in time.

In addition, a user may select snapshot reference type preferences according to directory, type of file or other criteria. In the example, the user selects a first preference 406 to use named data streams to reference snapshots under all directories, except the public directory 306. The user selects a second preference 408 to use extended attributes to reference snapshots under public directory 306. In other examples, a user may select snapshot reference types based on the type of file or based on whether the snapshot reference creation is triggered based on a write operation or a delete operation.

With reference now to FIG. 5, a high level logic flowchart depicts a process and program for controlling the creation and management of snapshot references in the file system directory. As illustrated, the process starts at block 500 and thereafter proceeds to block 502. Block 502 depicts file system controller 170 enabling settings for snapshot reference creation. For example, file system controller 170 may enable settings for snapshot reference creation from snapshot reference preferences 400 or from system administrator settings. Next, block 504 depicts a determination whether file system controller 170 detects a trigger for the creation of a snapshot reference. If a trigger for creation of a snapshot reference is detected, then the process passes to block 506.

Block 506 depicts determining the snapshot reference type for the copied file based on snapshot preferences 400. Next, block 508 depicts a determination of what type of trigger is detected.

At block 508, if the trigger is to automatically create a snapshot reference on detection of the creation of a snaphot or on the detection of a command to write to file, then the process passes to block 508. Next, block 518 depicts a determination of whether the snapshot reference creation is triggered on a delete command.

At block 518, if the snapshot reference creation is triggered on a delete command, then the process passes to block 520. Block 520 illustrates attaching the snapshot reference type (e.g. a named data stream or extended attribute) referencing a location of the snapshot to the directory holding the file that is copied and to be deleted. Next, block 522 depicts reattaching any snapshot references (e.g. named data streams or extended attributes) to the directory holding the file to be deleted, and the process ends. It will be understood that the actual deletion of the file name and file data from the file system responsive to a delete command may vary based on the file deletion methods used by a particular computer system.

Otherwise, at block 518, if the snapshot reference creation is not triggered on a delete command, then the process passes to block 524. Block 524 depicts attaching, to the current file in the file system directory, a snapshot reference (e.g. named data stream or extended attribute) referencing the location of the snapshot to the current file copied by the snapshot, and the process ends.

Returning to block 508, if the trigger is to create on discovery, then the process passes to block 512. Block 512 depicts sending a request to the file system for the locations of valid snapshots for current files within the discovery request. Next, block 514 illustrates dynamically creating and then attaching, to the current files within the discovery request, the snapshot references for the locations of the valid snapshots of the current files already within disk space, and the process ends.

While the invention has been particularly shown and described with reference to a preferred embodiment, it will be understood by those skilled in the art that various changes in form and detail may be made therein without departing from the spirit and scope of the invention.

What is claimed is:

1. A method for accessing a file system snapshot, wherein said file system snapshot comprises a copy of data from a file system within at least one storage device of a computer system, comprising:
creating a named data stream attached to an entry for said data in a file system directory for said file system, wherein said named data stream holds a reference to the storage location of said copy of said data within said storage device;
enabling access to said file system snapshot via said named data stream.

2. The method according to claim 1, wherein creating a named data stream attached to an entry for said data in a file system directory for said file system, further comprises:
enabling automatic creation of said named data stream upon creation of each file system snapshot; and
responsive to detecting a creation of said file system snapshot in said storage device, physically creating said named data stream attached to said entry for said data in said file system directory for said file system.

3. The method according to claim 1, wherein creating a named data stream attached to an entry for said data in a file system directory for said file system, further comprises:
enabling automatic creation of said named data stream for data represented by a file upon detecting a command to write to file; and
responsive to detecting a command to write to a particular file, creating said named data stream attached to said entry for said particular file in said file system directory for said file system.

4. The method according to claim 1, wherein creating a named data stream attached to an entry for said data in a file system directory for said file system, further comprises:
enabling automatic creation of said named data stream upon a request of a command to discover contents of at least one particular directory of said file system directory; and
responsive to detecting a command to discover contents of at least one particular directory, dynamically creating said named data stream attached to said entry for particular data in said at least one particular directory of said file system directory.

5. The method according to claim 4, further comprising:
responsive to detecting said command to discover contents of at least one particular directory, requesting a listing of locations within said storage device of all valid snapshots of data associated with said at least one particular directory; and
dynamically creating a separate named data stream for referencing each location of each valid snapshot of data associated with said at least one particular directory.

6. The method according to claim 1, further comprising:
responsive to a single command to list the entries for said file system directory, listing both said entry for said data and said named data stream in a single response.

7. The method according to claim 1, further comprising:
responsive to detecting a trigger to delete said data from said file system:
deleting said data from said storage device;
attaching said named data stream to a preceding directory within said file system directory; and
deleting said entry for said data from said file system directory

8. The method according to claim 1, wherein creating a named data stream attached to an entry for said data in a file system directory for said file system, further comprises:
creating said named data stream with at least one character identifying a type of said named data stream as referencing a file system snapshot.

9. The method according to claim 1, wherein said named data stream is an extended attribute, wherein an extended attribute is hidden unless specifically searched for in a discovery command.

10. A file system comprising an active file system snapshot, wherein said file system snapshot comprises a copy of data from a file system within a least one storage device of a computer system, said file system comprising:
a file system controller for controlling said file system, wherein said file system is managed through a file system directory stored in memory of said computer system;
said file system controller for creating a named data stream attached to an entry for said data in a file system directory for said file system, wherein said named data stream holds a reference to the storage location of said copy of said data within said storage device; and
said file system controller for enabling access to said file system snapshot via said named data stream.

11. The file system according to claim 10, wherein said file system controller further comprises:
means for enabling automatic creation of said named data stream upon creation of each file system snapshot; and
a file system snapshot thread for physically creating said named data stream attached to said entry for said data in said file system directory for said file system, responsive to detecting a creation of said file system snapshot in said storage device.

12. The file system according to claim 10, wherein said file system controller further comprises:
means for enabling automatic creation of said named data stream for data represented by a file upon detecting a command to write to file; and
a file system snapshot thread, triggered responsive to detecting a command to write to a particular file, for creating said named data stream attached to said entry for said particular file in said file system directory for said file system.

13. The file system according to claim 10, wherein said file system controller further comprises:
means for enabling automatic creation of said named data stream upon a request of a command to discover contents of at least one particular directory of said file system directory; and
a file system snapshot thread, triggered responsive to detecting a command to discover contents of at least one particular directory, for dynamically creating said named data stream attached to said entry for particular data in said at least one particular directory of said file system directory.

14. The file system according to claim 13, further comprising:
said file system snapshot thread, triggered responsive to detecting said command to discover contents of at least one particular directory, for requesting a listing of locations within said storage device of all valid snapshots of data associated with said at least one particular directory; and
said file system snapshot thread for dynamically creating a separate named data stream for referencing each location of each valid snapshot of data associated with said at least one particular directory.

15. The file system according to claim 10, wherein said file system controller, responsive to detecting a single command to list the entries for said file system directory, lists both said entry for said data and said named data stream in a single response.

16. The file system according to claim 10, said file system controller further comprising:
responsive to detecting a trigger to delete said data from said file system:
means for deleting said data from said storage device;
means for attaching said named data stream to a preceding directory within said file system directory; and
means for deleting said entry for said data from said file system directory

17. The file system according to claim 10, said file system controller for creating said named data stream with at least one character identifying a type of said named data stream as referencing a file system snapshot.

18. The file system according to claim 10, wherein said named data stream is an extended attribute, wherein an extended attribute is hidden unless specifically searched for in a discovery command.

19. A program for accessing a file system snapshot of a file system, wherein said file system snapshot comprises a copy of data from a file system within at least one storage device of at least one computer, said program embodied in a computer-readable medium, said program comprising computer-executable instructions which cause said computer to perform the steps of:
creating a named data stream attached to an entry for data referenced in a file system directory for a file system, wherein said named data stream holds a reference to the storage location of said copy of said data within said storage device;
enabling access to said file system snapshot via said named data stream.

20. The program according to claim 19, wherein said step of creating a named data stream attached to an entry for said data in a file system directory for said file system, further comprises the steps of:
enabling automatic creation of said named data stream upon a request of a command to discover contents of at least one particular directory of said file system directory, and responsive to detecting a command to discover contents of at least one particular directory, dynamically creating said named data stream attached to said entry for particular data in said at least one particular directory of said file system directory.
